(19) United States
(12) Patent Application Publication
(10) Pub. No.: US 2005/0135186 A1
(43) Pub. Date: Jun. 23, 2005

(54) Travel mug

(76) Inventor: Ivan Mbakop, Atlanta, GA (US)

Correspondence Address: LAW OFFICES OF CLEMENT CHENG, 17220 NEWHOPE STREET #127, FOUNTAIN VALLEY, CA, 92708, US

(21) Appl. No.: 10/741,060

(22) Filed: Dec. 19, 2003

(51) Int. Cl. B01F 13/02; B01F 11/00

(52) U.S. Cl. 366/101; 366/130; 366/276

(57) ABSTRACT

A beverage container comprising an outside housing, an inside housing nesting inside the outside housing, mounted to rotate freely around a vertical axis while inside the outside housing, a protrusion on the inside housing for manual rotation of the inside housing, and a vane attachment comprising at least one vane and attachable to the inside of the inside housing.

### BACKGROUND

The travel mug has been a widely popular car accessory for many years. While traveling in a car, many drivers drink coffee, orange juice or iced tea in their vehicles. A wide variety of mugs and mug handle 50 designs have been introduced in public since the beginning days of the cup holder. The cup holder has enabled all drivers to hold their favorite beverage while driving.

While the convenience of having a beverage on the road cannot be ignored, a driver may divert attention from driving and attend to the drink. A driver may add sugar and cream to coffee. A driver may also add sugar to iced teas. In orange juice, a driver may also prefer a high pulp orange juice. Because there is no easy way to stir the drink, having a beverage that requires mixing can be a hazard and diversion to the driver.

Other self mixing methods has been incorporated in beverage containers. The self-stirring pitcher as shown in U.S. Pat. No. 4,967,939 provides a mixing of liquid by pumping liquid from the bottom of the container to the top of the container through a hollow handle 50. This method requires pumping liquid.

### OBJECT OF THE INVENTION

To allow a person to hold a beverage container and stir its contents with only one hand.

### BRIEF DESCRIPTION OF THE DRAWINGS

FIG. 1 is an isometric view of the first embodiment.

FIG. 2 is a side sectional view of the first embodiment.

FIG. 3 is a side sectional view of the second embodiment.

FIG. 4 is an isometric view of the inside housing of the first embodiment.

FIG. 5 is a perspective view of upper portion of the inside housing, showing the elastic cord.

### DETAILED DESCRIPTION OF THE PREFERRED EMBODIMENT

Double Housing

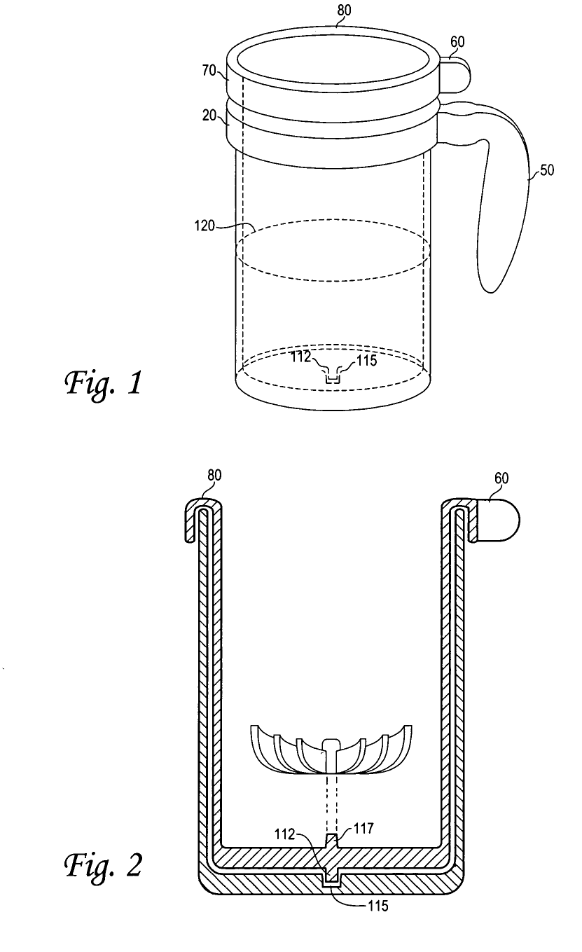

As shown on FIG. 1 and 2, the present invention includes a travel mug having an outside housing 20 and an inside housing 70. The inside housing 70 is preferably made of plastic. The outside housing 20 is preferably made of stainless steel. The outside housing 20 has a cylindrical configuration and is capable of holding an inside housing 70. The outside housing 20 has an axle connection to the inside housing 70 at the bottom center of the inside surface of the outside housing 20. The outside housing 20 has a connection to a handle 50. The handle 50 allows a user to hold the mug by hand. The handle 50 can be ergonomically shaped to a hand. A handle 50 is formed on the outside housing 20 so that a user holding the handle 50 can manipulate and rotate the inside housing 70.

The inside housing 70 freely rotates inside the outside housing 20. The inside housing 70 is connected to the outside by an axis of vertical rotation at the bottom portion of the inside housing 70. The inside housing 70 holds the beverage and is not porous or permeable by liquid. The inside housing 70 being cylindrical in basic configuration includes an axial connection to the inside of the outside housing 20.

The inside housing 70 has a protrusion nub 60 allowing a user to grasp the handle 50 with one hand, and stir contents of the beverage by manipulating and rotating the protrusion nub 60 mounted on the inside housing 70. The protrusion nub 60 allows a user to rotate the inside housing 70 with any finger or thumb while holding the handle 50 with the remainder of the hand. Alternatively, the protrusion nub 60 can be replaced by a depression on the surface of inside housing 70, whereby the depression forms a finger groove allowing a user to put his finger inside the depression and rotate the inside housing 70.

The protrusion nub 60 is shown as a tab extending from the upper portion of the inside housing 70. Preferably, the protrusion is placed on the portion of the inside housing 70 that covers the uppermost edge of the outside housing 20 forming a rim 80. The rim 80 is formed by the inside housing 70 extending over the top edge of the outside housing 20. Thus, a user's lips can drink from the beverage container touching only the rim 80 of the inside housing 70.

An improvement on the rotating inside housing 70 includes a spring element attached to the inside housing 70. The spring element exerts rotational force on the rotating inside housing 70. A user manipulating the inside housing 70 past an equilibrium position of rest creates potential energy stored within the spring. The spring pulls the inside housing 70 toward a neutral position which is also called the equilibrium position of rest and creates a reciprocating rotational motion of the inside housing 70 upon release of a user's finger. Vernacularly, the user flicks the inside housing 70 and the rotation with counter rotation mixes the beverage. The spring allows a user multiple counter rotations with a single flick.

The spring can be implemented as a pair of diametrically opposed elastic cords wound around the upper portion of the rotating housing. Here, the first rubber or polymer elastic cord 75 produces force pulling the inside housing 70 in a clockwise direction when the user exerts rotational force in a counterclockwise direction past the equilibrium position of rest. The second the elastic cord produces force pulling the inside housing 70 in a counterclockwise direction when the user exerts rotational force in a clockwise direction past the equilibrium position of rest. The spring can also be a metal leaf spring. Preferably, a single leaf spring is used for simplicity and cost. However, a pair of opposing the leaf springs can be used. A first leaf spring can exert rotational force in a counterclockwise direction past the equilibrium position of rest when a user produces force in a clockwise direction. A second leaf spring can exert rotational force in a clockwise direction past the equilibrium position of rest when a user produces force in a counterclockwise direction.

The axis of rotation is vertical. The inside housing 70 and outside housing 20 can be joined by a bearing. Preferably, a ball bearing, or mechanical steel bearing is not used because of cost and weight. However, acceptable substitute and the equivalent mechanical motion can be produced by forming a depression in the lower portion of the outside housing 20. If the outside housing 20 is made of stainless steel, the inside housing 70 should be made of plastic. A protrusion 112 fitting the depression of the lower portion of the outside housing 20 can be formed in the lower portion of the inside housing 70. The protrusion 112 protrudes from the bottom of the inside housing 70. The protrusion 112 and the depression 1 15 are coaxial and are positioned at the center of the bottom of the mug. The center of the mug thus receives the axis of rotation.

The interface between the inside housing 70 and the outside housing 20 is defined at an upper location at the top of the mug. A user generally drinks liquid from the top of the mug. Here, a user may use a drinking straw and suck the beverage from the container. The user may also drink the liquid without a drinking straw by pouring the liquid from the inside housing 70 into the mouth. The inside housing 70 forms a lip over the outside housing 20 which allows a user to drink from the top of the mug without a drinking straw. While an alternative embodiment can have the inside housing 70 and outside housing 20 interface within the mug, this is not preferable because spilled liquid accumulates between the inside housing 70 and outside housing 20.

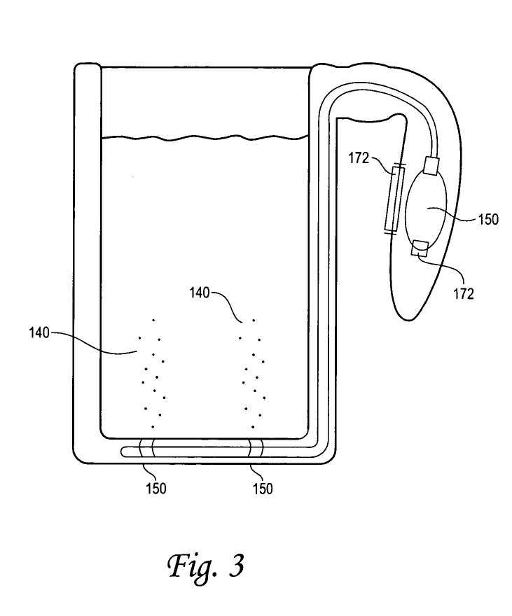

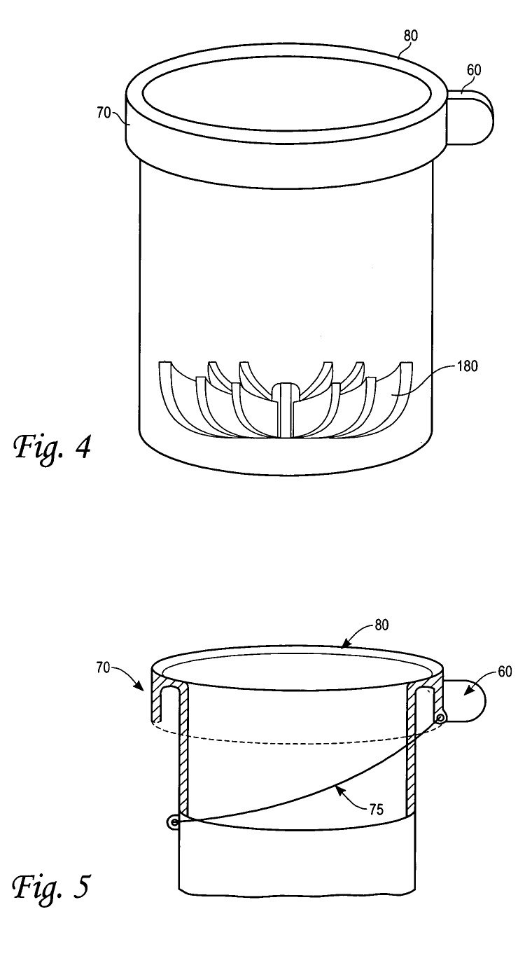

The mixing can be supplemented by an air pump housed within the handle 50 of the container. The handle 50 optionally contains a trigger 172 to bias an air bladder introducing a stream of air into the housing containing the liquid. The air pump embodiment can be implemented with the double housing by introducing the air into an air passage in the inside housing 70. As shown on FIG. 3, the air pumping option can also be implemented independently without a double housing by pumping air into a single housing. Preferably, the air is introduced into the bottom of the container so that air bubbles 140 have maximum travel time and distance.

A mixing attachment appearing as a fan with blades 180 has an attachment junction on its bottom. The attachment junction snaps onto the bottom of the inside housing for a snug fit. The mixing attachment can be removed by snapping it off of the bottom of the inside housing. By interference fit, the mixing attachment manually and releasable attaches, detaches and reattaches to the bottom of the inside housing. The mixing attachment preferably does not move relative to the inside housing 70. The mixing attachment preferably rotates relative to the outside housing 20 along the central axis of the beverage container.

The attachment junction can be formed in a variety of methods. The preferred method is forming the diameter of the mixing attachment so that it snugly fits against the sidewalls of the inside housing 70. Less preferred structures for the attachment junction include use of a protrusion fitting upon a groove. A protrusion can be formed in the mixing attachment at the attachment junction which fits into a groove formed within the bottom part of the inside housing 70. Conversely, a protrusion 117 can be formed in the bottom part of the inside housing 70 that attaches to a groove formed upon the mixing attachment.

The present invention not only can be presented as a mug, but it can also be applied to any cup-shaped container such as pitcher, kettle, etc.

Air Pump Handle 50

The handle 50 of the container can be formed as a single piece of plastic. The handle 50 may incorporate a handle holder that is molded around the top portion of the stainless steel outside housing 20. The handle holder secures the handle 50 to the mug. The container handle 50 protrudes from an upper position having an attachment at an upper end, but it may have an open lower end. In any case, a trigger 172 located within the handle 50 biases an air bladder which forces air through a tube-like air passage 150. The air passage 150 leads to the bottom of the inside member. The air passage can be mold inside or outside of the plastic bottom of the inside member. The air is released from the bottom of the inside member and travels through the liquid. A user can pump air by the handle 50 and use the air to cool the liquid. A user may thus control the temperature of his coffee by selectively introducing air into the inside member.

Call Out List of Elements

20 Outside Housing
50 Handle
60 Nub
70 Inside Housing
75 Elastic Cord
80 Rim
112 Protrusion
115 Depression
117 Protrusion
140 Air
150 Air Passage
172 Trigger
180 Mixing Attachment

1. A beverage container comprising:
a. an outside housing,
b. an inside housing, nesting inside the outside housing, mounted to rotate freely around a vertical axis while inside the outside housing,
c. a protrusion on the inside housing for manual rotation of the inside housing,
d. a vane attachment comprising at least one vane and attachable to the inside of the inside housing, the vane attachment not moving relative to the rotation of the inside housing,
e. a spring mounted in the upper portion of the rotating housing, the spring exerting rotational force opposing manual rotation biasing the inside housing to a neutral position relative to the outside housing.

2. The beverage container of claim 1 wherein a finger groove replaces the protrusion on the inside housing to allow a user to rotate the inside housing.

3. The beverage container of claim 1 wherein the spring is formed as an elastic cord formed as a loop attached to the inside housing and the outside housing.

4. The beverage container of claim 1 wherein the spring is formed as a metal spring attached to the inside housing and the outside housing.

5. The beverage container of claim 1 wherein the vane attachment attaches by interference fit into the bottom inside hollow of the inside housing.

6. The beverage container of claim 1 wherein the vane attachment attaches by interference fit and has a protrusion on-its bottom side that releasably attaches to a hole formed in the inside hollow of the inside housing.

7. The beverage container of claim 1 wherein the vane attachment attaches by interference fit and has a hole on its bottom side that releasably attaches to a protrusion formed in the inside hollow of the inside housing.

8. The beverage container of claim 1 further comprising a handle mounted on the outside housing and a hand air pump mounted on the handle moving air through a passage formed through the inside member that releases air from the inside bottom of the inside member.

9. The beverage container of claim 8 wherein a finger groove replaces the protrusion on the inside housing to allow a user to rotate the inside housing.

10. The beverage container of claim 8 wherein the spring is formed as an elastic cord formed as a loop attached to the inside housing and the outside housing.

11. The beverage container of claim 8 wherein the spring is formed as a metal spring attached to the inside housing and the outside housing.

12. The beverage container of claim 8 wherein the vane attachment attaches by interference fit into the bottom inside hollow of the inside housing.

13. The beverage container of claim 8 wherein the vane attachment attaches by interference fit and has a protrusion on its bottom side that releasably attaches to a hole formed in the inside hollow of the inside housing.

14. The beverage container of claim 8 wherein the vane attachment attaches by interference fit and has a hole on its bottom side that releasably attaches to a protrusion formed in the inside hollow of the inside housing.

15. A beverage container comprising:
a. an inside housing made of plastic, capable of fitting inside an outside housing,
b. an air pump mounted inside a handle and hand triggered drawing air from the ambient environment around the handle,
c. an air passage integrally formed with the inside housing receiving air from the air pump mounted inside the handle and releasing air from the inside bottom of the inside housing, whereby beverage contents are stirred.

16. The beverage container of claim 15 wherein the air passage formed in the inside housing is a tube.

17. The beverage container of claim 15 wherein the air passage is formed as a hollow in the inside housing.
